(19) United States
(12) Patent Application Publication
(10) Pub. No.: US 2024/0028353 A1
(43) Pub. Date: Jan. 25, 2024

(54) COMPUTER SYSTEMS AND COMPUTER-IMPLEMENTED METHODS FOR GATHERING DATA, AND ORGANIZING AND UTILIZING SUCH GATHERED DATA

(71) Applicant: SOCRATIC SCIENCES, INC., Boise, ID (US)

(72) Inventors: Steven Fredrick ELLIOTT, Ann Arbor, MI (US); Zachary David HILL, New York, NY (US); Karl Niklas LILJA, Tokyo (JP); Gregory B. STOCK, Boise, ID (US); Matthew E. SACHS, Brooklyn, NY (US)

(73) Assignee: SOCRATIC SCIENCES, INC., Boise, ID (US)

(21) Appl. No.: 18/376,918

(22) Filed: Oct. 5, 2023

Related U.S. Application Data
(63) Continuation of application No. PCT/US2022/023390, filed on Apr. 5, 2022.
(60) Provisional application No. 63/170,778, filed on Apr. 5, 2021.

(51) Int. Cl. G06F 9/451; H04L 67/306

(52) U.S. Cl. CPC G06F 9/451; H04L 67/306

(57) ABSTRACT

A computer-implemented method for gathering, organizing, and utilizing information about users utilizing a gaming or other interface can include generating, at a computing device having one or more processors, a customized user interface for each of a plurality of users. The customized user interface can present a series of questions to its associated user. The method can further include ingesting answers from each of the plurality of users and associating each user with his/her answers to form a user profile. A machine learning algorithm can be utilized to identify groupings of the plurality of users. Each particular grouping can include users whose user profile is in some manner more similar to the user profiles of other users in the particular grouping than to the user profiles of users in other groupings. The method can also include adapting the customized user interface for each user based on the user profiles.

### PRIORITY CLAIM

This application is a bypass continuation of PCT International Application No. PCT/US2022/023390, filed Apr. 5, 2022, which claims priority to U.S. Provisional Patent Application No. 63/170,778, filed on Apr. 5, 2021. Each patent application referenced above is hereby incorporated by reference as if fully set forth herein in its entirety.

### FIELD

The present disclosure relates to techniques for gathering data regarding human attitudes, values, aspirations, hopes, fears, and beliefs in general, as well as techniques for organizing such gathered data to form insights (identify interesting groups, commonalities, distinctions, etc.) and for utilizing such insights to provide highly-tailored solutions to individuals and groups of individuals.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

People interact with computing devices (mobile phones, tablets, laptops, smart speakers or other smart devices, desktop computers, etc.) in many ways. Users may opt to personalize their manner of interaction with their computing devices by changing the settings or otherwise personalizing their computing device (changing font size, colors, etc.). Furthermore, computing devices gather data from users in many ways, from location services, the applications that are used, the websites that are visited and with which the user interacts, and so on. Such gathered data is also utilized in many ways, including but not limited to developing new services, providing what can be described as “personalized” content/services (advertisements), and measuring the effectiveness of such personalized services. The type of data gathered, as well as the organization and categorization of such data, may be a suboptimal way to categorize, or make generalizations about, the user(s) to which the data belongs. It would be desirable to provide an improved system and computer-implemented method for gathering data that is more representative of a user to which the data belongs in order to better categorize and/or accurately reflect the user in order for the computer to provide highly-tailored content to the user.

### SUMMARY

In various embodiments of the present disclosure, a computer-implemented method for gathering, organizing, and utilizing information about users utilizing a gaming or other interface is disclosed. The method can include generating, at a computing device having one or more processors, a customized user interface for each of a plurality of users. The customized user interface can present a series of questions to its associated user and include a user input portion in which the associated user inputs answers to the questions. The method can further include ingesting, at the computing device, the answers from each of the plurality of users and associating, at the computing device, each user with his/her answers to form a user profile for each user. A machine learning algorithm can be utilized to identify groupings of the plurality of users. Each particular grouping can include users whose user profile is in some manner more similar to the user profiles of other users in the particular grouping than to the user profiles of users in other groupings. The method can also include adapting, at the computing device, the customized user interface for each user based on the user profiles.

In some aspects, utilizing the machine learning algorithm to identify groupings of the plurality of users can comprise clustering the user profiles of the users. Clustering the user profiles of the users can comprise using unsupervised learning. Alternatively or additionally, clustering the user profiles of the users can comprise using semi-supervised learning.

In some aspects, the method can further comprise generating, at the computing device, the series of questions for each user. Generating the series of questions for each user can comprise receiving an answer for a specific question from a particular user, and selecting a next question for the particular user based on the answer. Selecting the next question for the particular user based on the answer can comprise selecting the next question from a list of potential next questions. Alternatively or additionally, selecting the next question for the particular user based on the answer can comprise generating a differently worded version of the specific question as the next question.

In some aspects, generating the series of questions for each user can comprises utilizing an answer consistency machine learning algorithm to detect consistency between user answers, and generating multiple versions of a question, each of the multiple versions comprising a differently worded version of the specific question configured to elicit a consistent answer from the user.

In some aspects, the method can further comprise utilizing, at the computing device, the groupings of the plurality of users to generate or adapt a training program for each of the plurality of users.

In some aspects, the method can further comprise utilizing, at the computing device, the groupings of the plurality of users to identify groups of users likely to interact successfully with various dynamics.

In some aspects, the method can further comprise utilizing, at the computing device, the groupings of the plurality of users to generate or adapt anti-bias training tools for each of the plurality of users.

In some aspects, the method can further comprise utilizing, at the computing device, the groupings of the plurality of users to generate or adapt a self-learning training program for each of the plurality of users.

In some aspects, the method can further comprise utilizing, at the computing device, the groupings of the plurality of users to generate or adapt instruction materials for each of the plurality of users.

In some aspects, the method can further comprise reutilizing, at the computing device, the machine learning algorithm to identify new groupings of the plurality of users as additional answers or additional users are ingested.

In some aspects, the method can further comprise generating, at the computing device, a data map comprising all of the user profiles and the answers for all users to obtain an enriched dataset of user characteristics for all users.

In some aspects, the method can further comprise providing, at the computing device, a search engine interface for parsing, slicing, or otherwise searching the data map based on one or more aspects of the user characteristics. The search engine interface can permit an operator to generate different groupings of users by analyzing subsets of answers from the users. Alternatively or additionally, the search engine interface can permit an operator to identify groups of users that share a similar characteristic or groups of characteristics while disregarding other characteristics.

In some aspects, the method can further comprise recursively adapting the series of questions based on the answers ingested.

In various embodiments of the present disclosure, a computer-implemented method for customizing advertisements to users utilizing a gaming or other interface is disclosed. The method can include generating, at a computing device having one or more processors, a customized user interface for each of a plurality of users. The customized user interface can present a series of questions to its associated user and include a user input portion in which the associated user inputs answers to the questions. The method can further include ingesting, at the computing device, the answers from each of the plurality of users, and associating, at the computing device, each user with his/her answers to form a user profile for each user. Additionally, the method can comprise utilizing, at the computing device, a machine learning algorithm to identify groupings of the plurality of users. Each particular grouping can include users whose user profile is in some manner more similar to the user profiles of other users in the particular grouping than to the user profiles of users in other groupings. The method may further include retrieving, by the computing device and from an advertisement database, an advertisement template that comprises an advertisement to be served to a particular user of the plurality of users. The advertisement can include a customizable portion. Also, the method can comprise generating, by the computing device, customized content for the particular user based on a particular user profile for the particular user, and adapting, at the computing device, the advertisement for the particular user based on the customized content to generate a customized advertisement for the particular user. The method can further include serving, by the computing device and to a particular computing device associated with the particular user, the customized advertisement to the particular user.

In some aspects, utilizing the machine learning algorithm to identify groupings of the plurality of users can comprise clustering the user profiles of the users. Clustering the user profiles of the users can comprise using unsupervised learning. Alternatively or additionally, clustering the user profiles of the users can comprise using semi-supervised learning.

In some aspects, the method can include generating, at the computing device, the series of questions for each user. Generating the series of questions for each user can comprise receiving an answer for a specific question from a particular user, and selecting a next question for the particular user based on the answer. Selecting the next question for the particular user based on the answer can comprise selecting the next question from a list of potential next questions. Alternatively or additionally, selecting the next question for the particular user based on the answer can comprise generating a differently worded version of the specific question as the next question.

In some aspects, generating the series of questions for each user can comprise utilizing an answer consistency machine learning algorithm to detect consistency between user answers, and generating multiple versions of a question. Each of the multiple versions can comprise a differently worded version of the specific question configured to elicit a consistent answer from the user.

In some aspects, the method can include recursively adapting the series of questions based on the answers ingested.

### BRIEF DESCRIPTION OF THE DRAWINGS

The present disclosure will become more fully understood from the detailed description and the accompanying drawings, wherein:

FIG. 1 is a diagram of an example computing system including an example computing device and an example server computing device according to some implementations of the present disclosure;

FIG. 2 is a functional block diagram of the example computing device of FIG. 1;

FIG. 3 is an example graphical user interface corresponding according to some implementations of the present disclosure;

FIG. 4 is another example graphical user interface corresponding according to some implementations of the present disclosure;

FIG. 5 is a flow diagram of an example technique for gathering, organizing, and utilizing information about users utilizing a gaming or other interface according to some implementations of the present disclosure; and

FIG. 6 is a flow diagram of an example technique for customizing advertisements to users utilizing a gaming or other interface according to some implementations of the present disclosure.

### DETAILED DESCRIPTION

As previously discussed, a user of a computing device (a mobile phones, a laptop computer, a smart speaker or other smart device, a desktop computer, and the like) may interact with that computing device in many ways. Further, a computing device may gather data from and/or about its user using various techniques, organize the gathered data, and use that data in various ways in order to categorize the user and/or provide personalized content or personalized treatment. While such conventional data gathering techniques may be sufficient for certain tasks and goals, these conventional data gathering techniques fail to accurately capture the “true identity” of a user, which includes strong aspirational elements and value-driven behavioral frames, and thus, fail to provide a “true” personalization of the user. Accordingly, the present disclosure is directed to improved techniques for gathering, organizing, and utilizing user data that addresses the above noted and other issues/deficiencies associated with conventional data gathering techniques. Further details are included below.

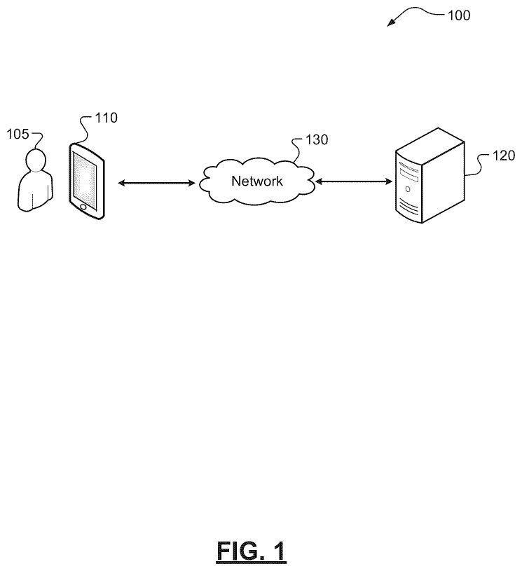

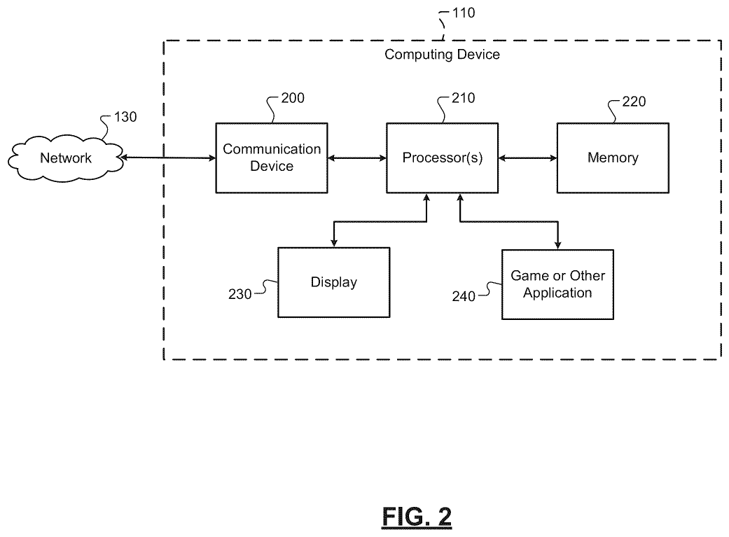

Referring now to FIG. 1, a diagram of an example computing system 100 is illustrated. The computing system 100 can be configured to implement one or more of the techniques described herein. The computing system 100 can include one or more example computing devices 110 and one or more example servers 120 that communicate via a network 130 according to some implementations of the present disclosure. For ease of description, in this application and as shown in FIG. 1, one example computing device 110 and one example server computing device 120 are illustrated and described. It should be appreciated, however, that there can be more computing devices 110 and more server computing devices 120 than is illustrated. While illustrated as a mobile phone (“smart” phones), each computing device 110 can be any type of suitable computing device, such as a desktop computer, a tablet computer, a laptop computer, a wearable computing device such as eyewear, a watch or other piece of jewelry, or clothing that incorporates a computing device. A functional block diagram of an example computing device 110 is illustrated in FIG. 2.

The computing device 110 can include a communication device 200, one or more processors 210, a memory 220, a display device 230, and a game or other application 240 (referred to herein as “game application 240”). The processor(s) 210 can control operation of the computing device 110, including implementing at least a portion of the techniques of the present disclosure. The term “processor” as used herein is intended to refer to both a single processor and multiple processors operating together, e.g., in a parallel or distributed architecture.

The communication device 200 can be configured for communication with other devices (e.g., the server computing devices 120 or other computing devices 110) via the network 130. One non-limiting example of the communication device 200 is a transceiver, although other forms of hardware are within the scope of the present disclosure. The memory 220 can be any suitable storage medium (flash, hard disk, etc., whether entirely local, remote, cloud-based, or any combination thereof) configured to store information. For example, the memory 220 may store a set of instructions that are executable by the processor 210, which cause the computing device 110 to perform operations, e.g., such as the operations of the present disclosure. The display device 230 can display information to the user 105. In some implementations, the display device 230 can comprise a touch-sensitive display device (such as a capacitive touchscreen and the like), although non-touch display devices are within the scope of the present disclosure.

It should be appreciated that the example server computing devices 120 can include the same or similar components as the computing device 110, and thus can be configured to perform some or all of the techniques of the present disclosure, which are described more fully below. Further, while the techniques of the present disclosure are described herein in the context of a computing device 110, it is specifically contemplated that each feature of the techniques may be performed by a computing device 110 alone, a plurality of computing devices 110 operating together, a server computing device 120 alone, a plurality of server computing devices 120 operating together, and a combination of one or more computing devices 110 and one or more server computing devices 120 operating together. Thus, the term “computing device” as used herein is specifically intended to include a cloud-based implementation in which one or more remote computing devices operate to perform the techniques of the present disclosure.

A game or other application 240 (referred to herein as the “game application 240”) can allow a user 105 to interact with her/his computing device 110 and, in some situations, other users. The game application 240 can be password protected such that only a certain user 105 may access the game application and any associated data. The game application 240 can store information locally at the computing device 110 (e.g., in memory 220) and/or remotely from the computing device 110 (e.g., on a cloud based server such as server computing devices 120 or an external database). In some embodiments, the user can access information by clicking an icon or link presented on the display 230 by the game application 240. Various example embodiments are described more fully below.

As mentioned above, the present disclosure is directed to techniques for gathering data regarding a user of a computing device. In practice, the techniques will be used to gather personal data regarding many, many individual users, which can then be utilized to generate groupings of users. Such generated groupings of users may more accurately categorize like-minded individuals, as well as more accurately distinguish between users that would otherwise be categorized together using other data gathering and organization techniques, including but not limited to various demographic, cultural, and psychographic factors individually or in combination, and potentially also including responses the various questions within the Game of Questions itself (see below). For ease of description, the data gathering techniques, which can include survey instruments and diverse other approaches, in addition to engaging mobile applications, will be referred to herein as the “Game of Questions” and the resulting gathered and organized data will be referred to as the “Map of Human Identity.” Both the Game of Questions and the Map of Human Identity can be utilized in various practical applications, which will also briefly be described, and will often rely on a variety of tools to extract, parse, manage, and deliver to individuals and other processes the insights and understandings extracted from the Map of Human Identity.

### Game of Questions

The Game of Questions is a tool for building a rich Map of Human Identity, which is an accumulated representation of human values and beliefs, of how we see ourselves and others, and of who we are, what we care about, and what we aspire too and seek in our lives. Moreover, it will be dynamic as it will evolve and change as our culture, our technology, and our connections to one another change us and the society we inhabit. This representation of ourselves and human society is built bottom up in that it is constructed by getting millions of people to reflect on difficult choices, project themselves into challenging situations, think about hard tradeoffs, and share and discuss their insights and experiences.

The Game of Questions itself will be ever more engaging as it evolves to support public sharing, facilitate face-to-face real time engagement, bring together compatible strangers, archive effectively, support personal journaling, enable self-discovery, enable easy access, support research, provide mechanisms for interpersonal skill assessment and development, catalyze meaningful discourse, and help people deepen their relationships.

The Game of Questions will amass considerable information about respondents over time. Intermittent psychographic and demographic questions, coupled with information gathered through short, tailored surveys, and revealing, value-laden dilemmas posed in unusual, intriguing ways will also be associated with certain behavioral data revealed by the way people interact with the user interface, will build rich profiles of regular users. The Game of Questions will be tailored to elicit honest, authentic responses to questions, and to discourage inauthenticity and dishonesty, as these would not only detract from the experience but undercut the accuracy of the Map of Human Identity. The Game of Questions will segment its database dynamically to compare and contrast population subgroups that are culturally relevant and interesting (so that people care about them), and that have enough respondents to provide meaningful data about group differences (so that people see the information as meaningful). Population groupings can be defined with progressively increasing specificity by including ever more parameters to further partition groups or by increasing the Map's size so that ever more precise and narrow population niches contain adequate numbers of individuals to be statistically meaningful. As such precision and breadth increases, groups that are relevant to ever more interests and uses will be available.

As more full discussed below, the Game of Questions can be adapted based on the data that is gathered in a recursive manner in order to better capture data. For example only, the Map of Human Identity can be utilized to generate, tailor, etc. the questions to be included in the Game of Questions or to be offered to particular populations within the Game of Questions. In addition or alternatively, the Map of Human Identity can be utilized to determine the presentation order, frequency, and/or character of the questions offered by the Game of Questions in order to elicit the most relevant/accurate/revealing data from users. In some aspects, machine learning algorithms can be utilized to generate meta-questions about responses to questions by different population subgroups or individuals, and/or to order or structure the presentation and selection of questions in the Game of Questions, and to provide additional insights about individuals and groups of users. In this manner, a computing device can automatically alter the Game of Questions based on the user and/or during the game itself based on the user's responses or the user's profile, or the profiles of other players in the game, since this is a social interactive game among both small and large groups, as well as a game for solitary play and reflection.

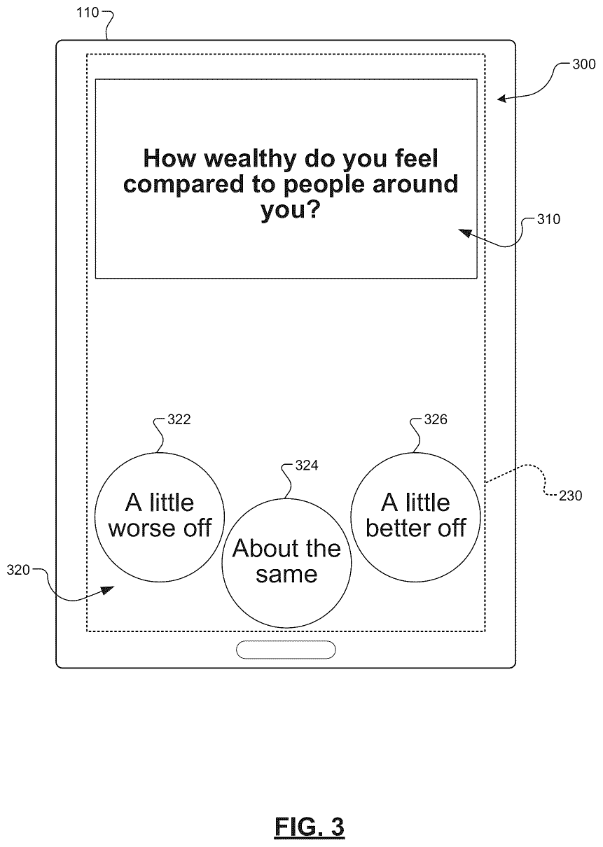

Referring now to FIG. 3, an example graphical user interface 300 corresponding to a game application 240 according to some implementations of the present disclosure is shown. In this example, the display 230 displays a portion of the graphical user interface 300. The graphical user interface (“GUI”) 300 includes a question portion 310 and an answer portion 320. In the illustrated example of GUI 300, the answer portion 320 includes a list of possible answers 322, 324, and 326 from which the user 105 can select. It should be appreciated that although GUI 300 shows three possible answers, the present disclosure contemplates that any number of answers can be presented the list of possible answers.

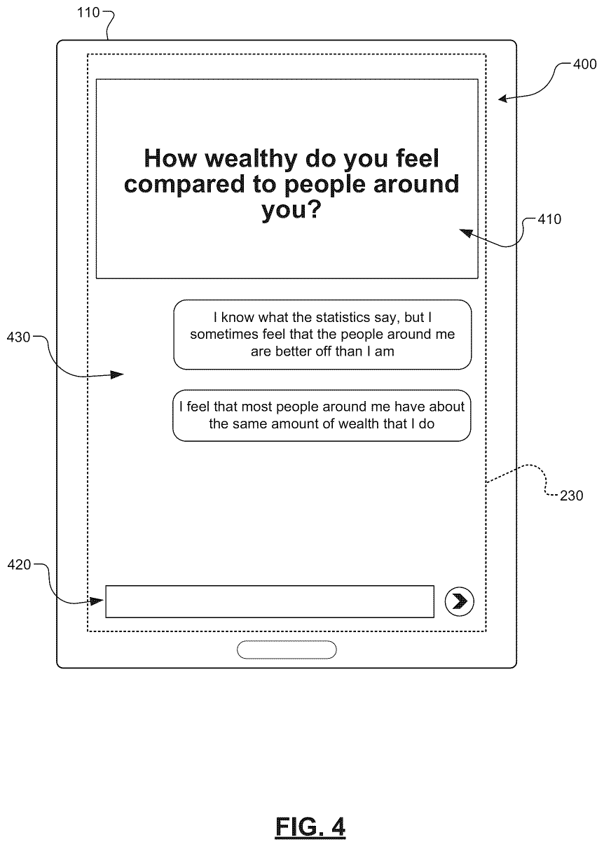

Referring now to FIG. 4, another example graphical user interface (“GUI”) 400 corresponding to a game application 240 according to some implementations of the present disclosure is shown. In this example, the display 230 displays a portion of the graphical user interface 400. Similar to GUI 300, GUI 400 includes a question portion 410 and an answer portion 420. In contrast to the list of possible answers 322, 324, 326 in GUI 300, however, the answer portion 420 includes a user input portion 422 in which a user 105 can provide a text input section that permits the user 105 to provide a narrative, free form answer to the question presented in the question portion 410. It should be appreciated that although the list of possible answers 322, 324, 326 and user input portion 422 are illustrated separately, in some aspects of the present disclosure the answer portion 320, 420 can include both a list of possible answers (multiple choice answers) and a text input section for the user to input a narrative, free form answer (e.g., if the choices in the list of possible answers do not adequately capture a user's answer and/or if the user wishes to provide additional information/context to a possible answer that is selected). In the illustrated example, the GUI 400 also includes a previous answer portion 430 that can include answers from other users 105, such as friends or other users participating in the Game of Questions that are known to the particular user 105, or even strangers. In this manner, users 105 can see how other users 105 answered a particular question in order to better craft their response.

The user interface 300, 400 can present a series of questions to a user 105 via the question portion 310, 410. As mentioned above, each question can be a multiple choice and/or open ended question that is capable of being answered by a user in a narrative form. In some aspects, a user 105 can be presented with a plurality of potential answers (e.g., in a list) to a question and also an option to provide an answer that differs from the potential answers (e.g., in a narrative form). It should be appreciated that any or all of these options are within the scope of the present disclosure.

The answers to the questions can be utilized to form a user profile for the user 105. For example only, a user can be associated with his/her/their answers to form the user profile. As described more fully below, a machine learning model can be utilized to identify groupings of users that have provided similar answers to questions. In this manner, users who have similar user profiles (e.g., users whose user profile is in some manner more similar to the user profiles of other users in the same particular grouping than to the user profiles of users in other groupings) can be grouped together.

In forming a user profile for a user 105, answers that are selected from a list of possible answers (sometimes called “multiple choice” questions, and including but not limited to, yes/no or true/false questions) may be easily compared to other users' answers. In some aspects, different answers from a list of possibly answers can also be grouped together in order to determine similar groupings. For example only, a list of possible answers that include the options “Strongly Agree,” “Agree,” “Neither Agree nor Disagree,” “Disagree,” and “Strongly Disagree” can be grouped together to reduce the number of options to “Agree” (including “Strongly Agree” and “Agree”), “Neither Agree nor Disagree,” and “Disagree” (including “Disagree” and “Strongly Disagree”). In this manner, users with different answers (e.g., “Strongly Agree” and “Agree”) may be deemed to have a similar/the same answer for a particular question during the grouping of user profiles.

In embodiments in which the user provides an answer that is not selected from a list of possible choices (e.g., in narrative form), the game application 240 can utilize one or more machine learning models to determine answers that are similar to one another when determining similar groupings of users. For example only, the game application 240 can use a natural language processing model to determine the meaning of a narrative answer provided by a user 105. Alternatively or additionally, the game application 240 can utilize a cluster analysis model to group (or “cluster”) answers in similar categories (or “clusters”). In this manner, narrative form or other types of answers that are not specifically selected from a list of possible answers can be meaningfully compared, e.g., when comparing user profiles in order to determine the groupings of users.

In some aspects, the user interface 300 can be adapted based on a user 105, such as based on the answers from the user 105 to previous questions, e.g., during a single question and answer session and/or from a previous user profile for the user 105. For example only, one or more machine learning models can be utilized to select a next question to present in the user interface 300. The one or more machine learning models can select the next question based on one or more features. In some aspects, the features can include a current user profile for the user 105, an answer to a previous particular question, answers to previous questions, and/or a combination thereof. In some aspects, the one or machine learning models can determine that a particular question (of the list of all potential questions) would provide a high level of distinguishing characteristics from a user 105 providing an answer. For example only, a machine learning model can determine, based on the current user profile for a user 105, that a question/answer combination will result in the most change in the user profile and present that question. In this manner, the user 105 can be presented with questions that are most likely to adapt a current user profile in order to reduce the time to provide the most accurate user profile for a user.

In such embodiments, the machine learning model utilized to generate the user profile for a user 105 can analyze each of the possible question/answer combinations for potential questions and determine a change amount for each possible question/answer combination. The change amounts can be compared and ranked to identify the question most likely to result in a high degree of change to a user profile. It should be appreciated that the change amount can be viewed as a change to a user profile as a whole, and/or an amount of change to particular aspects of a user profile can be analyzed. By utilizing the machine learning model to identify the question that may result in the greatest change to a user profile at a given point in time and then present that question to the user 105, the game application can most efficiently determine the most accurate user profile for a user 105.

### Map of Human Identity

The Map of Human Identity refers to the organized data that has been gathered from the Game of Questions, as well as through other means. In some aspects, the Map of Human Identity can combine the data (e.g., the user profiles) that has been gathered from the Game of Questions with other data/data types, such as typical demographic measures like age, gender, income, political persuasion, race and so on, either gathered from within the Game of Questions or through other processes, including third-party data aggregators.

The Map of Human Identity should be an incredible sociological tool for exploring the nuances of what it means to be human, our sense of who and what we are, and how both of these are changing overtime and within different individuals, populations, and subpopulations. This immense data structure will be increasingly interesting, potent, and useful as it grows, particularly as it comes to include: more countries, more cultures, more user diversity, more demographic and psychographic detail, more refined human groupings, more questions and meta-questions in ever more realms of experience, more active involvement of third party researchers, more robust tools to explore the content including open text, more user feedback, and more sophisticated machine learning to structure, massage, and organize it for human consumption, and more monitoring of how diverse people and groups interact with the game content and with one another in various forms of moderation within the game.

The Map of Human Identity will be distinct from the kinds of data that monitor and reveal our patterns of activity and behavior—the focus of most data collection today. The two realms are linked, but they deal with two different aspects of our lives: what we believe and what we do. It will be interesting to understand how these two realms relate, and explore the many ways in which they seem to align, and the many contradictions between how we see ourselves and how we actually behave.

The Map of Human Identity will be invaluable in framing the results of our ever deepening examination of the raw behavioral exhaust we now monitor so carefully to guide everything from product marketing to political messaging. This deluge of data tells us what we are doing, but our Identity Map will provide a deeper window into our psyches. It will tell us what we are seeking, what we yearn for, how we compare with the diverse others in the world we share, and how our ideas about such others align or diverge from reality.

In some aspects, the Map of Human Identity can be based upon the user profiles for the users 105 described above. The Map of Human Identity may comprise the groupings of the plurality of users 105, which may be determined, identified, described, etc. based on the user profiles and, more specifically, to the question/answer pairs upon which the user profiles are based.

In some aspects, the Map of Human Identity can be conceptualized as the entire data set corresponding to the questions and answers associated with the users. The Map of Human Identity can then be utilized to identify or determine any relevant grouping/categorization/etc. of the users 105 based on any set or subset of data (question/answers) combination deemed relevant. For example only, the Map of Human Identity can be utilized by one or machine learning models to determine groupings of users based on any number of question/answers combinations in order to identify groupings of relevance for a particular goal (such as the practical applications discussed herein).

### Practical Applications and Tools

There are many potential practical applications for the Map of Human Identity, the plurality of groupings, and/or the subsets of the data therein. As mentioned above, the Map of Human Identity can be used to generate, tailor, etc. the questions to be included in the Game of Questions in order to more easily obtain enriched data sets from users and provide more meaningful and diverse value to them. Additionally or alternatively, the Map of Human Identity can be used to generate more accurate and/or more finely atomized groups of users, which can be used by the computing device to automatically personalize content presented to users, or to bring together groups of individuals likely to interact successfully with various dynamics. Other practical applications of the Map of Human Identity include:
Generating, adapting, and presenting a guessing-game structure involving the comparisons of diverse deep demographic and psychographic human subgroups and populations about their attitudes and values, or subpopulations defined by corporate, academic, career, political, or stereotypic associations;
Generating, adapting, and presenting a training program for cross-cultural training of sales or other professional staff trying to operate with diverse demographic and international areas, and needing to better understand the populations they might interact with or collaborate with or associate with;
Generating, adapting, and presenting training, coaching, or other educational material related to educating people in interpersonal skill development, including how to interact with people from different backgrounds, professions, life and family experiences, and cultures, or other such potential subpopulations;
Generating, adapting, and presenting anti-bias training tools directed to identifying and correcting people's subconscious biases and misconceptions about the attitudes and beliefs of other people, by tailoring the focus and offering to people's blind spot or interests or needs, and by providing them actual information about these populations;
Generating, adapting, and presenting more powerful interactive groupings of people by balancing members values and communication styles and other MHI factors using machine learning algorithms when forming teams and groups, for example for corporate projects, sport teams, study groups, support groups, church and social groups, political groups, book clubs, etc.;
Generating, adapting, and presenting directives or guidance to catalyze discourse and to enable, support, or otherwise enhance discussion of beliefs, experiences, and various deep-value issues in social groups online or offline;
Generating, adapting, and presenting directives or guidance for use in identifying and serving the needs and interests of diverse individuals and subpopulations in highly tailored ways;
Generating, adapting, and presenting self-learning tools whereby people can better shape their decisions, such as career choices, which college cultures and other institutions and pursuits most suit them, and the like;
Using machine learning algorithms to place individuals in tailored groups of selected others who will be particularly compatible with them and their purposes because of similarities and/or differences in values, communications style, age, education, and other demographic and psychographic parameters of relevance (based on MHI info).
Generating, adapting, and presenting instructional materials used in tailored groups of people that are specifically personalized around group characteristics and purposes. Such tailoring might also include the selection of materials, the mode of presentation of materials, the frequency and pacing of presentations, and other relevant parameters of individual and group interaction and integration. The group purposes might include Education, focused learning, performance training, Corporate Team Building, social support, emotional support (for conditions such as loneliness, chronic disease, depression, and such), a desire to find friends, partners, and companionship, a desire to deepen existing relationships and/or enhance empathy and understanding of oneself and others, a desire to participate in interesting discourse about particular topics and common interests, passions, and goals, or questions of public policy and meaning, and the creation of peer groups to smooth transitions into universities, corporations, or other institutions, and to enhance success in these environments by optimizing healthy peer modeling, seeding beneficial long-term friendships and psychological support resources. Such groupings might be fashioned to be ephemeral or long lasting associations depending on the intended goals for the group, and might be focused primarily on the optimizing instructional materials for a particular group or towards optimizing the mix of people for personal support and intra-group relationship formation, and the moderation and management of such groupings might be tailored and individualized as well.

In some implementations, the present disclosure is directed to a computer-implemented method for gathering, organizing, and utilizing information about users. A computing device, such as one or more of the server computing devices 120, can implement the Game of Questions to gather the information/data to populate the Map of Human Identity from a plurality of users (such as user 105). For example only, a gaming interface can be utilized to implement the Game of Questions. The computing device can generate a customized user for each of the users 105. The customized user interface can present a series of questions to its associated user and include a user input portion in which the user can provide inputs/answers to the questions individually or in clusters. In this disclosure, the term “question” is intended to include any type of actual questions, including psychographic and demographic questions, situational dilemmas, and open-ended story-evoking questions, as well as statements, declarations, pictures, or any other type of content presented in order to provoke an answer or other response from a user (short tailored surveys, revealing, value-laden dilemmas, hypotheticals, etc.). The term “answer” is intended to include any type of response from a user, specifically including but not limited to an answer (from a multiple choice list, a free form natural language input, a yes or no input, etc.) and any reaction or response to a question (e.g., as sensed by a heart rate sensor, a pulse rat sensor, a camera, a microphone, or other type of sensor) that is received, detected, inferred, or otherwise obtained by the computing device.

The computing device can ingest the answers from each of the users and associate the users' answers to form a user profile for each user, and these can then be aggregated and de-identified for deep analysis and learning. In some aspects, the user profile for a user can include all of the answers obtained from the Game of Questions, as well as any other additional information related to the user (e.g., third-party cookies or other computer based, demographic, or other classification information) available regarding the user. In this manner, the user profiles for the users can be mapped to generate the Map of Human Identity described above.

As described herein, the Map of Human Identity can be utilized to segment or group users into various categories, clusters, or other groupings based on various features in the user profiles. Each particular grouping includes users whose user profile is in some manner more similar to the user profiles of other users in the particular grouping than to the user profiles of users in other groupings. For example only, one grouping can be based on age such that users that have the same age (or fall into the same age range) are in one group. In another example, a group can be based on an occupation. In another example, a group can be based on an answer to some value-oriented question. Groups can be based on one feature (age, occupation, question response etc.) or any number of features in combination. In some implementations, a machine learning algorithm can be utilized to identify the groupings, and to create relevant descriptive names for various complex, multi-factoral population groupings so that they can be readily and intuitively referenced. For example only, the machine learning algorithm can be a cluster analysis or other form of clustering process. Such clustering can be performed in an unsupervised, semi-supervised, or supervised manner.

In some aspects, the customized user interface for each user can be adapted based on the user profiles. In this manner, and as described above, the Game of Questions can be adapted based on the data that is gathered in a recursive manner in order to better capture data about its users. The computing device can generate the series of questions for each user, e.g., by receiving an answer for a specific question from a particular user and selecting a next question for the particular user or group of users based on the answer. Selecting the next question for the particular user or users based on the answer can include reordering questions within a list of questions (selecting the next question from a list of potential next questions) and/or generating a differently worded version of a specific question as the next question.

Additionally or alternatively, due to the importance of soliciting honest answers to questions, as described above, a machine learning algorithm may be utilized to detect inconsistency between answers or other forms of deception from users. For example only, the computing device may generate multiple versions of a question, where each of the multiple versions is a differently worded version of the specific question configured to elicit a consistent answer from the user. In this manner, a user may be presented with different questions configured to elicit consistent answers. When the computing device detects inconsistent answers from a user, for example, the computing device can adapt the series of questions presented to the user in order to obtain an accurate user profile, or eliminate that user's responses from the Map of Human Identity. The computing device may also recursively adapt the series of questions for each user based on the answers ingested such that a user's answers and/or other user(s)' answers change the series of questions during the Game of Questions, and better suit that person's objectives, interests, and learning mode.

As mentioned above, the user profiles of the users, the groupings of users, and the Map of Human Identity can be utilized in many practical applications. For example only, the Map of Human Identity can be utilized to generate groupings of users to generate or adapt a training program for each of the plurality of users, to identify groups of users likely to interact successfully with various dynamics, to generate or adapt anti-bias training tools for each of the plurality of users, to generate or adapt a self-learning training program for each of the plurality of users, and/or to generate or adapt instruction materials for each of the plurality of users. In some aspects, user feedback can be received to determine effectiveness of training materials, group projects, etc., which can be ingested to identify (through machine learning algorithms) appropriate groupings of users, or the most effective training materials, groups, training approaches etc. for a particular user. And use response statistics and other data can be used to create graded levels of complexity for both groups and the response statistics for different questions, so that sequencing of materials can be adapted to the progress and sophistication of those being instructed.

As the Game of Questions evolves and/or new users participate, the computing device can dynamically perform machine learning to update the groupings and/or Map of Human Identity. For example only, the machine learning algorithm can be reutilized to identify new groupings of the plurality of users as additional answers or additional users are ingested. Such reutilization can be performed continuously or periodically, when certain thresholds of additional information is ingested, or in many other consistent manners. In this way, the computing device can generate the most up-to-date, comprehensive, and useful data map that includes all of the user profiles and the answers for all users to obtain an enriched dataset of user characteristics for all users, referred to herein as the Map of Human Identity.

There can be various ways for an individual or group of individuals to interact with the Map of Human Identity in order to obtain the most useful, interesting, efficient, and/or effective information or groupings of users for a particular task or application. In some aspects, the computing device can provide a search engine interface for parsing, slicing, or otherwise searching or aggregating the data map based on one or more aspects of the user characteristics. The search engine interface can permit an operator to generate different groupings of users by analyzing subsets of answers from the users, by ignoring certain features in user profiles, by focusing on specific users, groups of users, or realms of responses, by weighting features individually to accentuate or diminish the effect of certain features in the groupings, and/or by otherwise manipulating the features within the data map/Map of Human Identity such that the machine learning algorithm is performed in the manner desired by the operator. In this manner, the search engine interface can permit an operator to identify groups of users that share a similar characteristic or groups of characteristics while disregarding other characteristics. Further, based on operator or other feedback, the machine learning algorithm can be adapted to provide more useful groupings in the feature by automatically determining the appropriate weights for features in the data map.

In some aspects, the Map of Human Identity can be utilized to provide customized advertisements to users based on the generated user profiles. As described herein, the Map of Human Identity can comprise the entire data set corresponding to the questions and answers associated with the users and may be more representative of how the users feel, think, interact, etc. than traditional forms of user segmentation (e.g., utilizing user demographics and/or user internet browsing history). Accordingly, the groupings identified by one or more machine learning algorithms/models based on the Map of Human Identity can more accurately reflect users that are “similar” to one another. Such groupings can be utilized to customize advertisements for users and/or select relevant advertisements for users.

In some implementations the present disclosure is directed to a computing system and a computer-implemented method for customizing advertisements to users utilizing a gaming or other interface. A computing device, such as one or more of the server computing devices 120, can implement the Game of Questions to gather the information/data to populate the Map of Human Identity from a plurality of users (such as user 105). For example only, a gaming interface can be utilized to implement the Game of Questions. The computing device can generate a customized user for each of the users 105. The customized user interface can present a series of questions to its associated user and include a user input portion in which the user can provide inputs/answers to the questions individually or in clusters. In this disclosure, the term “question” is intended to include any type of actual questions, including psychographic and demographic questions, situational dilemmas, and open-ended story-evoking questions, as well as statements, declarations, pictures, or any other type of content presented in order to provoke an answer or other response from a user (short tailored surveys, revealing, value-laden dilemmas, hypotheticals, etc.). The term “answer” is intended to include any type of response from a user, specifically including but not limited to an answer (from a multiple choice list, a free form natural language input, a yes or no input, etc.) and any reaction or response to a question (e.g., as sensed by a heart rate sensor, a pulse rat sensor, a camera, a microphone, or other type of sensor) that is received, detected, inferred, or otherwise obtained by the computing device.

The computing device can ingest the answers from each of the users and associate the users' answers to form a user profile for each user, and these can then be aggregated and de-identified for deep analysis and learning. In some aspects, the user profile for a user can include all of the answers obtained from the Game of Questions, as well as any other additional information related to the user (e.g., third-party cookies or other computer based, demographic, or other classification information) available regarding the user. In this manner, the user profiles for the users can be mapped to generate the Map of Human Identity described above.

As described herein, the Map of Human Identity can be utilized to segment or group users into various categories, clusters, or other groupings based on various features in the user profiles. Each particular grouping includes users whose user profile is in some manner more similar to the user profiles of other users in the particular grouping than to the user profiles of users in other groupings. For example only, one grouping can be based on age such that users that have the same age (or fall into the same age range) are in one group. In another example, a group can be based on an occupation. In another example, a group can be based on an answer to some value-oriented question. Groups can be based on one feature (age, occupation, question response etc.) or any number of features in combination. In some implementations, a machine learning algorithm can be utilized to identify the groupings, and to create relevant descriptive names for various complex, multi-factoral population groupings so that they can be readily and intuitively referenced. For example only, the machine learning algorithm can be a cluster analysis or other form of clustering process. Such clustering can be performed in an unsupervised, semi-supervised, or supervised manner.

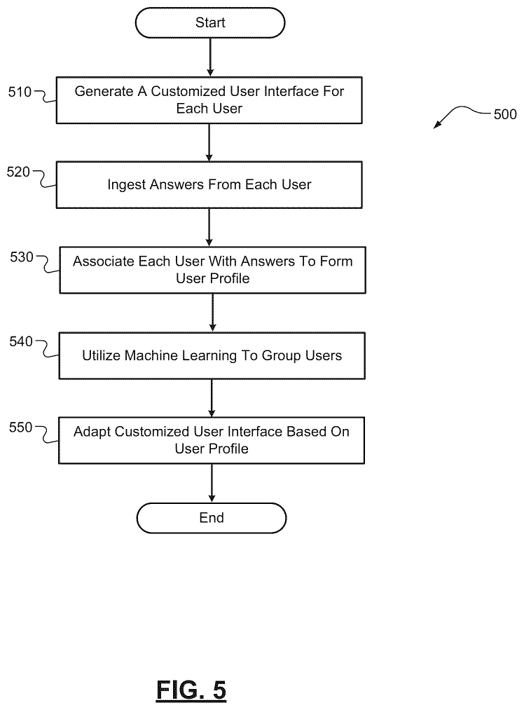

Referring now to FIG. 5, an example computer-implemented method 500 for gathering, organizing, and utilizing information about users utilizing a gaming or other interface is disclosed. The method 500 can be performed by any computing device or devices, such as computing device 110, server computing device 120, and/or a combination thereof. For ease of description, the method 500 will be described hereinafter as being performed by a single computing device (server computing device 120). It should be appreciated, however, that other devices may be utilized to perform some or all of the described method 500.

At 510, the server computing device 120 can generate a customized user interface 300, 400 for each of a plurality of users 105. The customized user interface 300, 400 can present a series of questions (typically, but not necessarily, one at a time) to its associated user 105. The customized user interface 300, 400 can include a user input portion 320, 420 in which the associated user can inputs answers to the questions. At 520, the server computing device 120 can ingest the answers from the plurality of users and (at 530) associate each user with his/her answers to form a user profile for each user. The server computing device 120 can utilize a machine learning model or algorithm to identify, at 540, groupings of the plurality of users based on the user profiles. Each particular grouping can include users whose user profile is in some manner more similar to the user profiles of other users in the particular grouping than to the user profiles of users in other groupings. As described herein, the machine learning model may comprise a clustering algorithm, although other types of machine learning models are within the scope of the present disclosure. At 550, the server computing device 120 can adapt the customized user interface for each user based on their user profile.

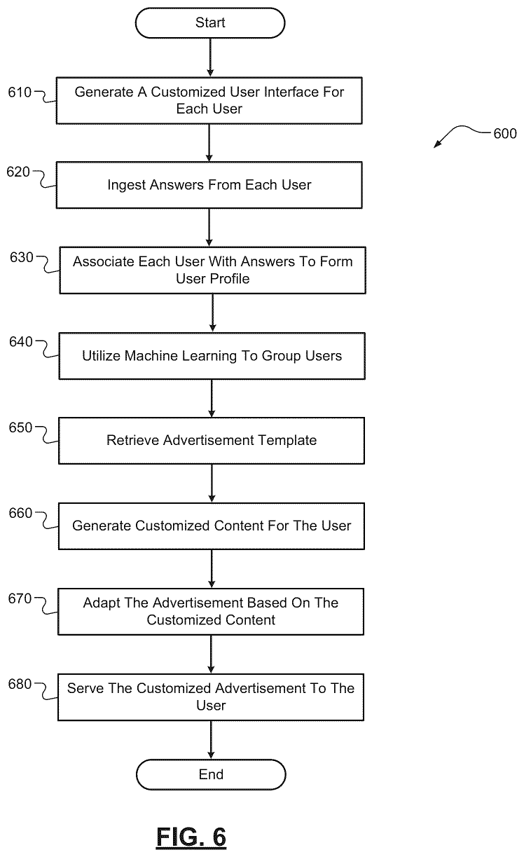

Referring now to FIG. 6, an example computer-implemented method 600 for customizing advertisements to users utilizing a gaming or other interface is disclosed. Similar to method 500 discussed above, the method 600 can be performed by any computing device or devices, such as computing device 110, server computing device 120, and/or a combination thereof. For ease of description, the method 600 will be described hereinafter as being performed by a single computing device (server computing device 120). It should be appreciated, however, that other devices may be utilized to perform some or all of the described method 600.

At 610, the server computing device 120 can generate a customized user interface 300, 400 for each of a plurality of users 105. The customized user interface 300, 400 can present a series of questions (typically, but not necessarily, one at a time) to its associated user 105. The customized user interface 300, 400 can include a user input portion 320, 420 in which the associated user can inputs answers to the questions. At 620, the server computing device 120 can ingest the answers from the plurality of users and (at 630) associate each user with his/her answers to form a user profile for each user. The server computing device 120 can utilize a machine learning model or algorithm to identify, at 640, groupings of the plurality of users based on the user profiles. Each particular grouping can include users whose user profile is in some manner more similar to the user profiles of other users in the particular grouping than to the user profiles of users in other groupings. As described herein, the machine learning model may comprise a clustering algorithm, although other types of machine learning models are within the scope of the present disclosure.

The method can further include retrieving, at 650, an advertisement template that comprises an advertisement to be served to a particular user of the plurality of users. In some embodiments, the server computing device 120 can retrieve an advertisement template from an advertisement database or other storage device separate from but in communication with the server computing device 120. The advertisement template can comprise an advertisement to be served to users (such as a particular user of the plurality of users) and can include a customizable portion and a generic portion. The generic portion can be unmodified and presented as-is to any and all users who are served the advertisement. In contrast, the customizable portion can be modified or otherwise adapted to better match the particular user to whom the advertisement will be served. For example only, the computing device can generate customized content for the particular user based on the user profile for the particular user. The computing device can adapt the advertisement for the particular user based on the customized content to generate a customized advertisement for the particular user, which can then be served to a particular computing device associated with the particular user.

As described herein, the advertisement can include a customizable portion. At 660, the server computing device 120 can generate customized content for the particular user 105 based on a particular user profile for the particular user. The server computing device 120 can also adapt (670) the advertisement for the particular user based on the customized content to generate a customized advertisement for the particular user, and serve (680) the customized advertisement to the particular user 105, e.g., to a particular computing device 110 associated with the particular user 105.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known procedures, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or” includes any and all combinations of one or more of the associated listed items. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

As used herein, the term module may refer to, be part of, or include: an Application Specific Integrated Circuit (ASIC); an electronic circuit; a combinational logic circuit; a field programmable gate array (FPGA); a processor or a distributed network of processors (shared, dedicated, or grouped) and storage in networked clusters or datacenters that executes code or a process; other suitable components that provide the described functionality; or a combination of some or all of the above, such as in a system-on-chip. The term module may also include memory (shared, dedicated, or grouped) that stores code executed by the one or more processors.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for gathering, organizing, and utilizing information about users utilizing a gaming or other interface, comprising:
generating, at a computing device having one or more processors, a customized user interface for each of a plurality of users, the customized user interface presenting a series of questions to its associated user and including a user input portion in which the associated user inputs answers to the questions;
ingesting, at the computing device, the answers from each of the plurality of users;
associating, at the computing device, each user with his/her answers to form a user profile for each user;
utilizing, at the computing device, a machine learning algorithm to identify groupings of the plurality of users, wherein each particular grouping includes users whose user profile is in some manner more similar to the user profiles of other users in the particular grouping than to the user profiles of users in other groupings; and
adapting, at the computing device, the customized user interface for each user based on the user profiles.

2. The computer-implemented method of claim 1, further comprising:
generating, at the computing device, the series of questions for each user.

3. The computer-implemented method of claim 2, wherein generating the series of questions for each user comprises:
receiving an answer for a specific question from a particular user; and
selecting a next question for the particular user based on the answer.

4. The computer-implemented method of claim 3, wherein selecting the next question for the particular user based on the answer comprises generating a differently worded version of the specific question as the next question.

5. The computer-implemented method of claim 2, wherein generating the series of questions for each user comprises:
utilizing an answer consistency machine learning algorithm to detect consistency between user answers; and
generating multiple versions of a question, each of the multiple versions comprising a differently worded version of the specific question configured to elicit a consistent answer from the user.

6. The computer-implemented method of claim 1, further comprising:
reutilizing, at the computing device, the machine learning algorithm to identify new groupings of the plurality of users as additional answers or additional users are ingested.

7. The computer-implemented method of claim 1, further comprising:
generating, at the computing device, a data map comprising all of the user profiles and the answers for all users to obtain an enriched dataset of user characteristics for all users.

8. The computer-implemented method of claim 7, further comprising:
providing, at the computing device, a search engine interface for parsing, slicing, or otherwise searching the data map based on one or more aspects of the user characteristics.

9. The computer-implemented method of claim 8, wherein the search engine interface permits an operator to generate different groupings of users by analyzing subsets of answers from the users.

10. The computer-implemented method of claim 1, further comprising recursively adapting the series of questions based on the answers ingested.

11. A computer-implemented method for customizing advertisements to users utilizing a gaming or other interface, comprising:
generating, at a computing device having one or more processors, a customized user interface for each of a plurality of users, the customized user interface presenting a series of questions to its associated user and including a user input portion in which the associated user inputs answers to the questions;
ingesting, at the computing device, the answers from each of the plurality of users;
associating, at the computing device, each user with his/her answers to form a user profile for each user;
utilizing, at the computing device, a machine learning algorithm to identify groupings of the plurality of users, wherein each particular grouping includes users whose user profile is in some manner more similar to the user profiles of other users in the particular grouping than to the user profiles of users in other groupings;
retrieving, by the computing device and from an advertisement database, an advertisement template that comprises an advertisement to be served to a particular user of the plurality of users, the advertisement including a customizable portion;
generating, by the computing device, customized content for the particular user based on a particular user profile for the particular user;
adapting, at the computing device, the advertisement for the particular user based on the customized content to generate a customized advertisement for the particular user; and
serving, by the computing device and to a particular computing device associated with the particular user, the customized advertisement to the particular user.

12. The computer-implemented method of claim 11, wherein utilizing the machine learning algorithm to identify groupings of the plurality of users comprises clustering the user profiles of the users.

13. The computer-implemented method of claim 12, wherein clustering the user profiles of the users comprises using unsupervised learning.

14. The computer-implemented method of claim 12, wherein clustering the user profiles of the users comprises using semi-supervised learning.

15. The computer-implemented method of claim 11, further comprising:
generating, at the computing device, the series of questions for each user.

16. The computer-implemented method of claim 15, wherein generating the series of questions for each user comprises:
receiving an answer for a specific question from a particular user; and
selecting a next question for the particular user based on the answer.

17. The computer-implemented method of claim 16, wherein selecting the next question for the particular user based on the answer comprises selecting the next question from a list of potential next questions.

18. The computer-implemented method of claim 16, wherein selecting the next question for the particular user based on the answer comprises generating a differently worded version of the specific question as the next question.

19. The computer-implemented method of claim 15, wherein generating the series of questions for each user comprises:
utilizing an answer consistency machine learning algorithm to detect consistency between user answers; and
generating multiple versions of a question, each of the multiple versions comprising a differently worded version of the specific question configured to elicit a consistent answer from the user.

20. The computer-implemented method of claim 11, further comprising recursively adapting the series of questions based on the answers ingested.
